(19) United States
(12) Patent Application Publication
(10) Pub. No.: US 2005/0090159 A1
(43) Pub. Date: Apr. 28, 2005

(54) Electrical wiring device

(76) Inventors: Robert R. Luther, East Haven, CT (US); Arnold M. Tang, Stanford, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/702,563

(22) Filed: Nov. 5, 2003

Related U.S. Application Data
(60) Provisional application No. 60/515,376, filed on Oct. 28, 2003.

(51) Int. Cl. H01R 4/48

(52) U.S. Cl. 439/835

(57) ABSTRACT

Electrical wiring devices and methods of connecting leads to wiring devices are disclosed comprising terminal blades, cage clamps, insulating housings and hand-operable actuators for engaging and disengaging the cage clamps, wherein the actuators are integral to the wiring devices. The connection of leads to wiring devices using cage clamps and integral, hand-operable actuators produces improved safety, durability and performance of the wiring devices.

### RELATED APPLICATIONS

This application claims priority to U.S. Provisional Application Ser. No. ______ entitled “ELECTRICAL WIRING DEVICE” filed Oct. 28, 2003 on behalf of Robert R. Luther and Arnold R. Tang. The entire disclosure of that application is incorporated herein by reference.

### BACKGROUND OF THE INVENTION

1. Field of the Invention

The invention described herein relates generally to the field of wiring devices and specifically to the field of wiring devices incorporating cage clamps.

2. Description of the Related Art

Wiring Devices are a well-defined product category of electrical connectors utilizing straight or curved blades for male contacts and complimentary resilient blades for female contacts. Harvey Hubbell invented the first wiring device in 1897. The contacts of modem wiring devices are arranged in configuration patterns that ensure non-interchangeability for varying voltage ratings and their capacities range from 10 amps at 120 volts to 60 amps at 600 volts. The National Electrical Manufacturers Association (hereinafter “NEMA”) defines the configuration patterns for many wiring devices. The products falling within this family of wiring devices are known as NEMA wiring devices.

FIG. 1a is an exploded view of a typical existing male wiring device 100. The wiring device 100 is used to provide a standard termination for a wire lead 10. The wire lead 10 passes through a passage 15 in a closed end of a generally tubular insulating backshell 120 and is secured within an insulating insert 108 where it is connected to one or more terminal blades 105, 106. The insulating insert 108 that is illustrated includes a somewhat cylindrical body that mates with and fits within the insulating backshell 120 to hold and insulate the terminal blades 105, 106. The blades 105, 106 are typically metallic and are flat and rectangular in shape, although some existing blades 105, 106 commonly used are curved or shaped into pin-type blades. The blades 105, 106 are mounted in and supported by the insulating insert 108, which can also serve to provide, in part, a location for a user to hold the wiring device 100 without touching the blades 105, 106. The illustrated wiring device 100 also includes a pin-type blade for a grounding pin 106. The illustrated grounding pin 106 has been formed into a round pin. FIG. 1b is an end view of the wiring device 100 of FIG. 1a illustrating the circular cross-section of the wiring device 100 along with the terminal blades 105 and the grounding pin 106.

Traditional wire termination methods use exposed screws to provide the necessary physical force to effect physical and electrical connection between a wire, or a set of wires, and a wiring device. FIG. 1c is a cutaway exploded side view of the male wiring device 100 of FIG. 1b taken along line 1-1, and illustrates two existing connection designs utilizing screws for connecting the lead 10 to the terminal blades 105. FIG. 1d is a cutaway side view of a female wiring device 102, taken along a similar line in that device as FIG. 1c, that is adapted to mate with the wiring device 100 of FIG. 1c. The female wiring device 102 has female blades 107 that are made in a similar manner as the male wiring device blades 105 and are shaped to resiliently mate with the terminal blades 105 of the male wiring device 100. A female insulating insert 115a supports the female blades 107 and provides a housing to accept the male blades 105 and house the connection between the male and female blades 105, 107. Common wiring devices 100 can also include a termination insulator 118 for housing and insulating the connection between the terminal blades 105 and the lead 10. The termination insulator 118 can be many shapes, depending upon the termination scheme utilized, but generally consists of a hollow geometric shape attached to the insulating insert 115 or a separate internal insulator 116. The internal insulator 116 is used in some wiring devices 100 for additional electrical and thermal insulation and consists of a disk of insulative material that abuts the insulating insert 115 and has passages for the terminal blades 105 and grounding pin 106.

Referring to FIG. 1c, the illustrated wiring device 100 includes two existing termination structures. One termination structure is enclosed in a termination insulator 118 and the other is not. The first, exposed termination scheme is a common and simple “binding screw terminal” 122 that consists simply of a threaded screw 126 that screws into the terminal end of the terminal blade 105. Typically, wire from the lead 10 is wrapped around the binding screw 126 and the screw 126 is tightened to physically secure and electrically connect the wire to the terminal blade 105. The compression force of the binding screw 126 is limited because the forces it presents to a connected wire are not just compressive, but also frictional, as the screw is rotated. Such termination structures are subject to failure as the binding screw loosens from vibration and electro-thermal expansion and contraction of the terminal blade 105, screw 126, and wire.

The construction of wiring devices has advanced over the years to embody a screw drawing two clamps together upon the conductor to make the electrical connection. Still referring to FIG. 1c, an existing improvement to the binding screw 126 is illustrated as the compression terminal 124. A compression terminal 124 is similar to a binding screw 126, in that a screw 127 is inserted through the terminal blade 105. However, a compression plate 128 is added to compress the wire between the compression plate 128 and the terminal blade 105. The compression plate 128 is a flat piece of threaded metal that is drawn toward the terminal blade 105 as the screw 127 is tightened, thereby clamping the wire to the terminal blade 105. This arrangement allows the terminated wire to be clamped with greater compression than is possible with binding screw terminals 122, reducing or delaying loosening effects caused by vibration and by electro-thermal expansion and contraction.

Referring to FIGS. 1a and 1c, the insulating backshell 110 is assembled onto the back of the wiring device 100, after the terminations are complete, to house the termination and, as mentioned before, to allow a location for a user to hold, connect, and disconnect the wiring device 100 without touching electrified components. Many wiring devices 100 include a cable clamp 130. The cable clamp 130 is an opening in the insulating backshell 120 through which a lead penetrates. Once assembled, the cable clamp 130 is engaged, and mechanically secures the lead 10 to the completed wiring device 100 so as to prevent damage to the individual wires and terminations within.

These screw-type terminations are common in the field of electrical devices, however, the screw methods for such connections have several drawbacks. The first problem is creep. The fine strands of a stranded copper conductor can have a tendency to shift and further compress, even when the screw is tightened with the proper amount of torque. This shifting may result in a reduction of clamping pressure applied to the conductor, leading to a rise in heat generated from the connection. Heating and cooling of the conductors may result in further shifting of the conductors, and ultimately device failure.

Vibration is another action that can reduce the effectiveness of screw terminals. Vibration from motors or other machinery, or transport of the wiring device can cause screws to loosen leading ultimately to device failure. Furthermore, such terminations can be negatively affected by insufficient initial torque. It is up to the installer to apply the proper amount of torque to screws to make a proper electrical connection. It is rare for an installer to use a torque screwdriver, so resultant insufficient torque is not uncommon. Insufficient torque will result in inadequate contact pressure applied to the conductor, again leading to a rise in heat from the connection and eventual device failure. Applying too much torque to a terminal screw, or “overtorquing,” can cause problems as well. Overtorquing the terminal screw can result in stripping the terminal screw as well as physical damage to the lead. A stripped terminal screw will provide inadequate pressure on the conductor resulting in a rise in heat generated be the connection and ultimately device failure.

Furthermore, screws require a screwdriver for assembly, which can be a source of injury to personnel and can be inconvenient in complicated installations. Additionally, in situations where the insulating shell of the wiring device accidentally comes loose, the screws can be exposed to the operator and contacted and thereby present an electric shock hazard to users of these wiring devices.

Alternative connection mechanisms to screws include the “spring clamp” and “cage clamp.” These items usually constitute a bent piece of banded metal that “creates” a resilient spring action that provides the required force for physical and electrical connection. FIGS. 2a, 2b and 2c illustrate wiring devices 200 utilizing existing “spring clamp” or “cage clamp” terminations for connectors and wiring devices. The cage or spring clamps utilized currently are not applied to NEMA wiring devices due to the size of the conductors that are involved in such devices, but rather, are applied to small circuitry for electronic equipment. FIGS. 2a, 2b and 2c only illustrate the termination of one of the terminal blades 205 and the associated components for that termination for simplicity only. The terminations of the other terminal blades that are not shown in these figures are made in the same way with similar components for the other lead wires and terminal blades 105. As illustrated in FIGS. 2a, 2b and 2c, a cage clamp is employed by locating a specially shaped spring 210 within the termination insulator 218. The spring 210, as illustrated in the detail, is a flat band of metal that is folded into a resilient shape with an opening for passage of a lead. The spring 210 is typically metallic and is fashioned by stamping, machining, and other metalworking processes. During its manufacture, a hole 215 or channel is typically fashioned into the spring 210, as shown in the detail view. In its normal (disengaged) state, the spring retains a shape such that the hole is located mostly adjacent the terminal blade 205 and so that a wire to be terminated cannot be inserted into the hole 215 until the spring 210 is activated.

An operating opening 220 is formed in the termination insulator 218 and allows a user top apply an operating force to a portion of the spring 210, thereby compressing it into an “engaged” state, whereby the exposed portion of the hole 215 in the spring 210 is enlarged enough for an electrical conductor to pass through. Termination of a wire in a “cage clamp” is effected by placing physical force upon the spring 210 to place it into its “engaged” state, inserting a wire in the hole 215, and then removing the engaging force. The spring 210 returns toward its disengaged state, causing the side of the hole 215 to bear force upon the wire, effecting a mechanical and electrical connection to the terminal end of the terminal blade 205.

FIGS. 2b and 2c illustrate a typical cage clamp termination utilized in electronic circuitry. The engaging force “F” is applied to the spring by forcing a pointed tool or object into the operating opening 220 to engage the spring 210. The hole 215 in the spring 210 is sufficiently exposed to allow a wire or conductor 225 to pass through. Upon the removal of the engaging force F, the wire or conductor 225 is trapped in the hole 215 and thereby terminated against the terminal end of the terminal blade 205.

The side of the hole 215 in the spring 210 provides a constant force upon the terminated conductor 225 under a variety of circumstances, which can present reliability problems for termination methods utilizing screws. Screws can become loosened under vibration, whereas the spring 210 will not loosen. The terminal 205 and wire 225 expand and contract as they heat up and cool as the electrical load through them varies, which can cause termination methods using screws to work loose. In contrast, a spring 210 will maintain the same force despite this electro-thermal expansion and contraction.

One disadvantage of the “cage clamp” design is that in many embodiments the engaging force F is not mechanically limited. Excessive engaging force F can cause permanent damage to the spring 210. Existing “spring clamp” and “cage clamp” designs as shown in FIGS. 2a, 2b and 2c also present a risk of electrical shock should the connector/wiring device's 200 insulating backshell (not shown in these figures) become loose or detached, because the spring 210 is exposed through the operating opening 220. Some embodiments, as represented in FIG. 2a, reduce the size of the operating opening 220 to reduce, but not totally eliminate, the risk of electric shock. This increases the need to utilize a sharp or pointed tool such as a screwdriver, thereby reducing convenience and increasing assembly time and complexity.

Therefore, there is a need for an improved wiring device that does not require a tool such as a screwdriver to operate, that provides a reliable electrical and mechanical connection and that provides an amount of protection from electrical shock to the user while connections are being made between the device and a lead. There is an additional need for a wiring device that utilizes a termination mechanism that consistently applies the correct amount of clamping force to a conductive lead. There are additional needs in the field of wiring devices that are met by the embodiments described herein that will become apparent to those of skill in the art upon reviewing the description of the various embodiments described herein.

### SUMMARY OF EMBODIMENTS OF THE INVENTION

An electrical wiring device is described in one embodiment, comprising a conductive terminal, a resilient cage clamp having a terminal opening adapted to accept the passage therethrough of a portion of the terminal, the cage clamp also having an actuation surface adapted to enlarge the terminal opening when the actuation surface is depressed, a cage clamp actuator located in close proximity to the actuation surface so as to depress said actuation surface when the cage clamp actuator is operated, and an insulating housing partially enclosing the terminal and the cage clamp and configured to retain at least a portion of the actuator. In this embodiment, the actuator is adapted for hand-operation in order to depress said actuation surface. Some embodiments conform to NEMA design standards.

Some embodiments of the electrical wiring device further comprise an insulating cover adapted to mate with the housing and to encapsulate the cage clamp, the actuator and to partially enclose the terminal.

In other embodiments of the electrical wiring device, the actuator further comprises a rotatable cam adapted to rotate between at least a first cam position and a second cam position, wherein when the cam is in the first cam position, the actuation surface is fully released and wherein when the cam is in the second cam position, the actuation surface is fully depressed, and a cam lever attached to the cam and adapted to rotate the cam into the first and second cam positions.

In yet another embodiment, an electrical wiring device is disclosed comprising; a blade-type wiring terminal, a cage clamp in contact with the terminal, wherein the cage clamp is adapted to receive and retain an electrical lead when actuated, and wherein the cage clamp is further adapted to electrically and mechanically couple the wiring terminal with the electrical lead, and the electrical wiring device further comprises an integral hand-operated actuator in proximity to the clamp and adapted to actuate the cage clamp.

In still another embodiment, a method of manufacturing a wiring device is disclosed, comprising molding a blade-shaped terminal, forming a, opening in a middle section of a flat resilient conductor, forming the conductor generally into a loop with the opening along a middle portion of the loop, extending the terminal partially through the opening, forming a nonconductive actuator with a handle adapted to displace a portion of the conductor, wherein the actuator is formed such that it is capable of being operated by hand, and the method further comprising housing the conductor, the terminal and the actuator in an insulative body in a manner such that the terminal is generally parallel with the plane of the loop while extending partially within the opening and such that the actuator is in operable proximity with at least a portion of the resilient conductor. In some embodiments, the body houses the conductor, the terminal and the actuator in a manner such that the resilient conductor rests at a state where the majority of the opening is misaligned with the terminal, and the resilient conductor can be displaced from its rest position to a position such that the opening is aligned with the terminal to form an opening into which a conductive lead may be inserted, such that when the resilient member is returned to its rest position, it impinges the inserted lead against the terminal.

### BRIEF DESCRIPTION OF THE DRAWINGS

FIG. 1a is an exploded perspective view of an existing wiring device.

FIG. 1b is an end view of the wiring device of FIG. 1a.

FIG. 1c is a partial cutaway side view of the wiring device of FIG. 1b taken along line 1-1 and illustrating two existing termination schemes.

FIG. 1d is a partial cutaway side view of a female wiring device complimentary to the male wiring device of FIG. 1c, taken from a corresponding female wiring device along a line analogous to line 1-1 of FIG. 1b.

FIGS. 2a and 2b are partial cutaway side views of wiring devices similar to that illustrated in FIG. 1b taken along line 1-1 and illustrating existing termination schemes utilizing a cage clamp for small electronics applications.

FIG. 2c is a partial cutaway side view of the wiring device illustrated in FIG. 2b and illustrating the retention of a lead by the cage clamp.

FIG. 3a is a partial cutaway side view of the wiring device of FIG. 1b taken along line 1-1 and illustrating an operating lever for activating a cage clamp.

FIG. 3b is a partial cutaway side view of the wiring device of FIG. 3a illustrating an operating force applied to the operating lever of the device of FIG. 3a to engage the cage clamp.

FIGS. 4, 4a and 4b are partial cutaway side views of an alternative wiring device utilizing an actuating pin as an integrated actuator.

FIGS. 5, 5a, 5b and 5c are partial cutaway side views of an alternative wiring device utilizing an actuating lever and “cam”.

FIGS. 6 and 6a are partial cutaway side views of another alternative wiring device utilizing an actuating lever, a cam and a push “rod”.

FIG. 7 is a perspective and partial cutaway view of the assembled embodiment of the wiring device of FIGS. 5, 5a, 5b and 5c.

FIG. 8a is a partial cutaway side view of an alternative to the embodiment illustrated in FIG. 7.

FIG. 8b is a perspective and partial cutaway view of the wiring device of FIG. 8a.

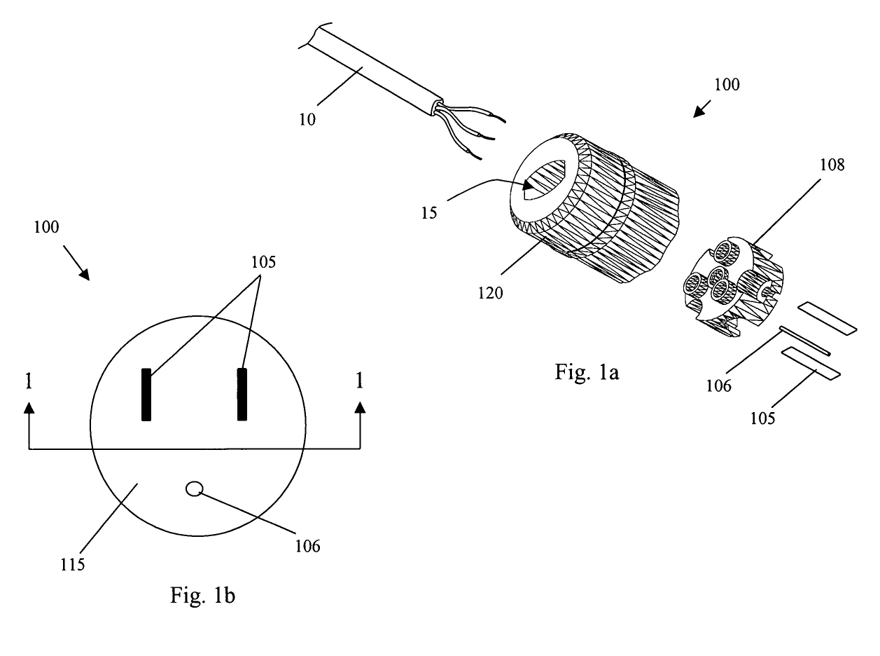

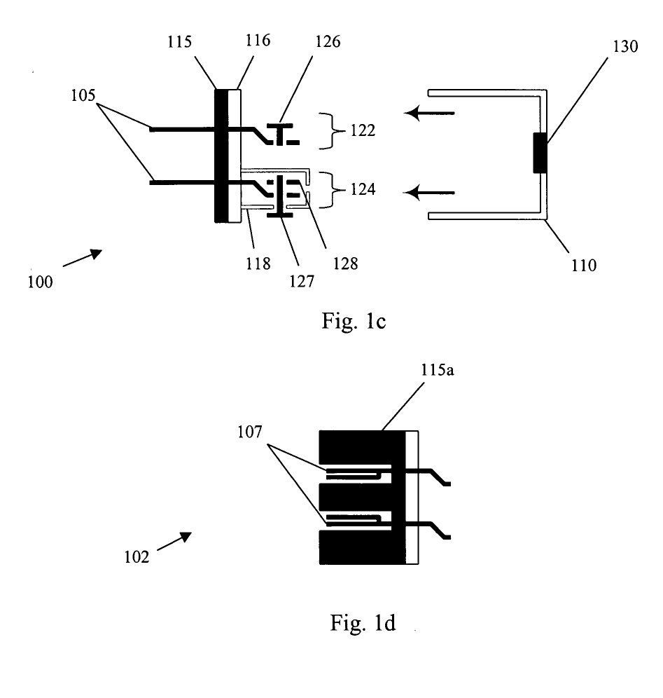

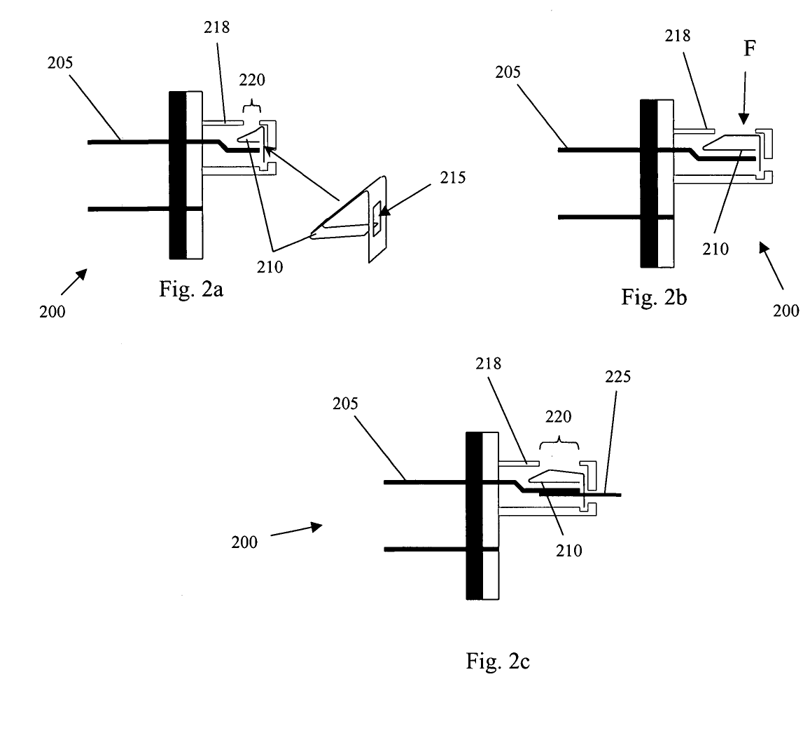

### DETAILED DESCRIPTION OF PREFERRED EMBODIMENTS

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described. The figures and descriptions in the balance of this application describe male connectors and wiring devices, although the inventions disclosed are equally applicable to female connectors and wiring devices. Many figures in the balance of this application also illustrate the termination of a single terminal or a single conductor, although the inventions disclosed are applicable to connectors and wiring devices with any quantity of terminals or conductors.

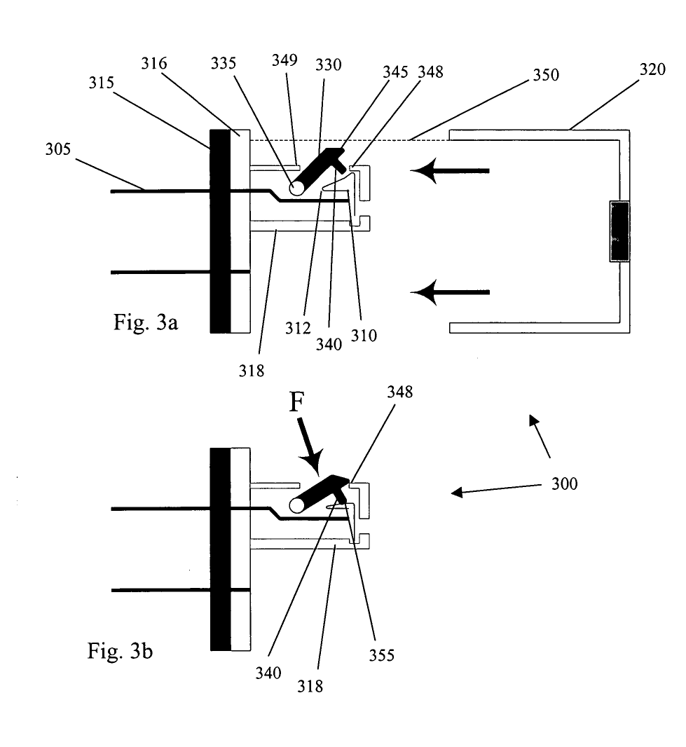

FIGS. 3a and 3b illustrate a wiring device 300 utilizing an integral actuator for activating, holding and releasing a cage clamp 310 by hand, without the need of a tool. The actuator of this embodiment is an operating lever 330 for activating a cage clamp 310. The embodiment illustrated includes common components described above, such as, one or more terminal blades 305, an insulating insert 315, an internal insulator 316, a termination insulator 318 and an insulating backshell 320. Many of these components can be combined, such as the insulating insert 315 and the internal insulator 316 or the termination insulator 318, as design conditions for a particular embodiment may allow. However, this embodiment also includes an insulating operating lever 330 with a hinge 335, which cooperate to insulate the user from the cage clamp 310 while also allowing activation of the cage clamp 310 by hand and without the need for tools.

As illustrated in FIG. 3a, embodiments of the wiring device 300 include an elongated operating lever 330 for actuation of the cage clamp 310. The operating lever 330 can be any elongated piece of rigid material mounted generally at or near one end via a pin joint to form the hinge 335 such that the rest of the operating lever 330 can rotate about the hinge 335. The operating lever 330 is further shaped with an operating pin 340 generally opposite the hinge 335. The operating pin 340 is a lateral extension protruding generally perpendicularly from the axis of the elongated operating lever 330 that transmits an engaging force to an appropriate point upon the cage clamp 310. The operating pin 340 can be made of any material that is either conducting or non-conducting, and can be fashioned as a separate component or formed as part of the operating lever 330. The operating pin 340 is positioned and shaped so as to provide a mechanical advantage or disadvantage, amplifying or attenuating the engaging force applied to the operating lever 330.

For instance, for easier operation, the operating pin 340 is situated such that it contacts the cage clamp 310 at a point far from the dynamic bend 312 of the horizontal side of the cage clamp 310 that mates with the terminal blade 305. The dynamic bend 312 of the cage clamp 310 is the bend/part that most elastically deforms during activation and deactivation of the cage clamp 310. By contacting the cage clamp 310 at a point far from this dynamic bend 312, the cage clamp 310 is easier to activate while making a termination. By forming the operating pin 340 and lever 330 in a manner such that the operating pin 340 applies force to the cage clamp 310 at a location near the dynamic bend, the cage clamp 310 becomes more difficult to operate. Embodiments incorporating such design features allow manufacturers to create wiring devices that are advantageous for the particular size of connectors that are to be connected to the wiring device 300. For instance, if a smaller thickness conductor is to be connected to the wiring device 300, some embodiments employ an operating lever 330 and pin 340 combination that is more difficult to operate. In such a design, a user observes the size of the conductor and the size of the wiring device 300 and contemplates a range of force that he/she expects to be required for activation of the cage clamp 300. When the actuator design provides resistance to the activation force near the maximum of that contemplated range, it is unlikely that an operator would apply significantly more than he/she expects to be the top of that range. Therefore, fewer instances of over-compressing the cage clamp are expected to occur, leading to even greater reductions of the number of failures in such devices.

The operating lever 330 of the embodiments illustrated in FIGS. 3a and 3b also includes a mechanical stop 345, which is an extended area of the rotating end of the lever 330. The mechanical stop 345 limits the travel of the lever 330 during compression of the cage clamp 310 by contacting the termination insulator 318 at a stop point 348 shaped and located to cooperate with the mechanical stop 340 of the lever 330. In some embodiments, the range of rotation of the lever 330 is limited in the other direction by a back stop 349. The back stop 349 is an area of the opening in the termination insulator 318 that serves as a stopping point for the rotation of the lever 330 when the cage clamp 310 is being released. In other words, the range of rotation of the lever 330 and thus the operating pin 340 is limited by the size of the opening in the termination insulator 318. Alternatively, on embodiments not utilizing a termination insulator 318, the stop point 348 and the back stop 349 can be any other structure capable of limiting the rotation of the lever 330 in the forward or reverse directions. For instance, the stop point 348 and the back stop 349 can be two or more struts extending from one area inside the insulating insert 315, internal insulator 316 or the insulating backshell or any other component. Additionally, the operating lever 330 may include its own rotation range limiting extensions (not shown) extending from anywhere along the length of the lever 330 out and away from the longitudinal axis of the lever 330 in a straight or curved path. As such extensions stretch out from the lever 330, they hinder the lever 330 from rotating more than the design travel.

In many embodiments, the operating lever 330, the hinge 335, the operating pin 340 and the termination insulator 318 are cooperatively shaped such that electrically energized portions of the cage clamp 310 and terminal blade 305 are minimally exposed. In many embodiments, physical contact with electrically conductive components can only be made by extreme or deliberate acts by a user, even when the insulating backshell 320 is accidentally or deliberately removed.

When the operating lever 330 is operated to either extreme of travel, an optional tactile feedback “click” is transmitted to a person operating the lever thereby letting them know that such a limit has been reached. Such a tactile feedback can be created by a variety of means including matching protrusions molded into the lever 330 and the termination insulator 318, the stop point 348 or the back stop 349 that closely mate to provide the desired feedback. In some embodiments, this feedback mechanism can also hold the lever 330 in the position that engages the cage clamp 310, allowing a conductor (not shown) to be inserted into the cage clamp 310 without requiring continuous engagement force.

The operating lever 330 of some embodiments is shaped such that when the insulating backshell 320 is installed, the entire lever 330 remains clear of the inside surface of the insulating backshell 320. A line 350 illustrates the path of the internal surface of the insulating backshell 320 and shows how the lever 330 remains clear and does not contact the backshell 320 at any point. Such a configuration prevents accidental operation of the lever 330 while the wiring device is fully assembled.

FIG. 3b illustrates the embodiment of FIG. 3a in the activated or engaged position. In this illustrated embodiment, an activating force F is applied by simple, manual finger pressure. The operating pin 340 contacts the cage clamp 310 at a contact point 355 thereby compressing the cage clamp 310 and positioning the cage clamp hole (not shown) below the terminal blade 305 and allowing a wire to be inserted into the hole. The lever 330 and the termination insulator 318 of certain embodiments are specially shaped such that they contact at stop point 348, thereby preventing excessive compression of the spring, and thereby preventing plastic deformation of the spring. The cage clamp 310 is engaged by the operating pin 340 in such a manner as to provide an opening for connecting a wire or lead to pass through the hole and into the cage clamp 310 adjacent the terminal blade 305. Once the wire is inserted, the lever 330 is released into its original or disengaged position, where it is held in this position by the cage clamp 310.

Referring to FIGS. 3a and 3b, the operating lever 330 may be made of any material that can be formed into a shape capable of operating the cage clamp 310 and capable of applying the amount of force required to activate the cage clamp 310. The embodiment illustrated can be designed for a variety current ratings. Many embodiments are designed to accept leads capable of reliably conducting up to 10 amps, 20 amps, 30 amps, 40 amps, 50 amps and more. In embodiments capable of higher current conductance, a stronger cage clamp 310 is utilized to provide the resilient force necessary to make and hold a reliable electrical connection. Accordingly, the operating lever 330 of these embodiments is constructed of a design and material capable of supplying the appropriate amount of force. For example, in embodiments where the cage clamp 310 is designed to provide a high amount of clamping force to the lead when an electrical connection is made, the operating pin 340 is more robust to provide more force and a material is selected to support the additional force. Many embodiments utilize materials that are electrically insulative and thermally stable. For example, many embodiments utilize thermoplastic or thermoset materials, such as polyvinyl chloride, or polyvinyl acrylonitrile, although any such plastic can be used. Additionally, other materials can be used including but not limited to glass products, resins, fiberglass, metals, ceramics or any rigid material.

The hinge 335 of many embodiments is made of a metallic or nonmetallic pin formed from any of the materials discussed above that is either separate from or integral with the operating lever 330. In such embodiments, the pin forming part of the hinge 335 is inserted into a hole formed in the lever 330. In some embodiments, the hinge 335 is molded or integrated into the lever 330 and fits into holes formed in the termination insulator 318 or other structure.

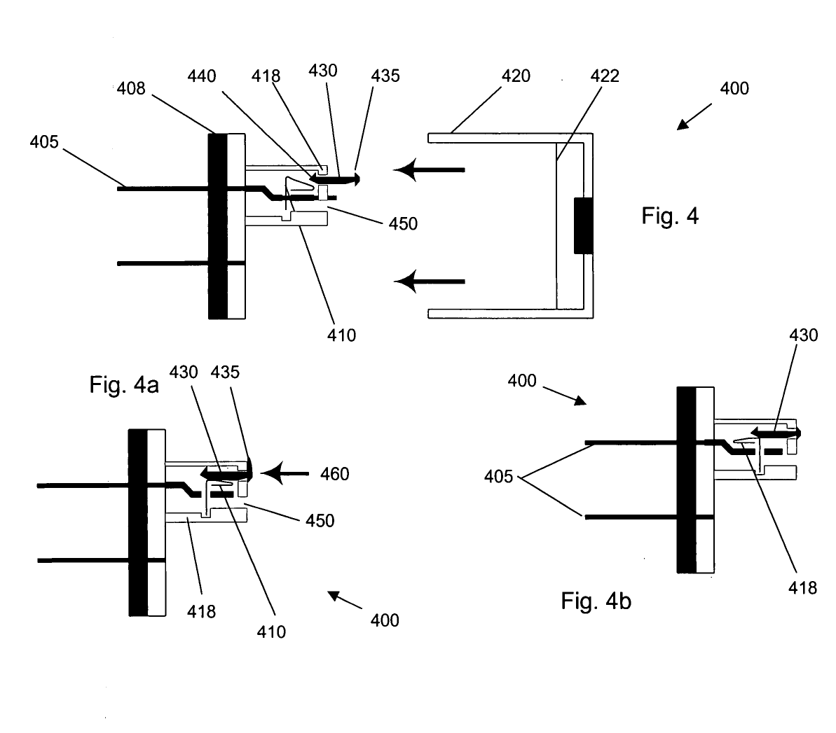

FIGS. 4, 4a and 4b illustrate a wiring device 400 having an alternate integral actuator. These embodiments also have terminal blades 405, an insulating insert 408, an insulating backshell 420, and a termination insulator 418, as those parts are described above. In this embodiment, the integral, insulating and hand-operated operating actuator is an operating pin 430 that slides within the termination insulator 418 to activate the cage clamp 410. The pin 430 of many such embodiments is a longitudinal shaped part having a first operating end 435 and a second actuating end 440 opposite the operating end 435. The pin 430 extends through the termination insulator 418 with the operating end 435 extending outside the termination insulator 418 and the actuating end 440 remaining within the termination insulator 418.

The operating end 435 of the pin 430 is designed to allow a user to engage and disengage the pin 430 and thereby engage and disengage the cage clamp 410. In the embodiment illustrated, the operating end is similar to the widened or flattened end of a nail or a pin. Such a flattened area creates a wider area to allow operation by a user by hand and without the need of a tool. Modifications of the illustrated embodiment include larger of the widening of the operating end such that the operating end extends beyond the termination insulator 418 to provide an extending edge to disengage the pin 430. Other embodiments of the wiring device 400 utilize different shapes of the operating end 435 that have ridges or other forms to allow the user to grip and apply extra disengaging force if required.

The activating end 440 of the pin 430 is designed to function as a cam in that as the pin 430 is inserted into the termination insulator 418 it applies a lateral engaging force to the cage clamp 410. The conversion of the longitudinal motion of the pin 430 into the lateral engaging force needed to operate the cage clamp 410 is the main function of the activating end 440. As illustrated in FIGS. 4 and 4a, when the pin 430 is pushed inward into the termination insulator 418, the activating end 440 begins to apply activating force to engage the cage clamp 410. The shape and size of the activating end 440 can also limit the amount of activating force applied to the cage clamp 410. By limiting the amount of force that can be applied to the cage clamp 410 with the design of the activating end 440, it is possible in these embodiments to prevent over-compressing and plastically deforming the cage clamp 410. Again, preventing such over-compression increases the reliability of such wiring devices 400 because the plastic deformation of resilient springs leads to released resilience and clamping force, which can cause failure of wiring devices.

FIG. 4a illustrates the full insertion of the pin 430 into the termination insulator 418 thereby fully engaging the cage clamp 410. This embodiment also illustrates an extended operating end 435 that extends beyond the end of the termination insulator 418 so that it can be easily disengaged. As can be illustrated by FIG. 4, the inside depth 422 of the backshell 420 is designed such that the pin 430 can be in the fully retracted position as in FIG. 4 when the backshell 420 is installed. In such embodiments, the cage clamp 410 applies its clamping force to the mated connection when the pin 430 is retracted, and therefore, the backshell 420 provides such room.

The pin 430 of the embodiment illustrated in FIGS. 4, 4a and 4b can be made of any rigid material, and may be cylindrical or polygonal in shape and cross-section. The pin 430 of some embodiments includes ridges either along its length where it passes through an opening in the termination insulator 418 or at the activating end 440 that indicate one or more positions to the user. For instance, one ridge can indicate a point at which the pin 430 is fully inserted or another to indicate when the pin 430 is fully extracted.

In some embodiments, when the pin 430 is fully extracted, the length of the pin 430 is such that the operating end 435 forms a stripping gauge. The distance between the termination insulator 418 and the raised or sharpened gauge point of the operating end 435 indicates to a user the correct length of insulation to be stripped from a wire that is to be inserted into a lead hole 450 and mated with the terminal blade 405. The lead hole 450 is an opening in the termination insulator 418 through which a bare lead to be connected to the wiring device 400 is inserted. The lead hole 450 is aligned with the passage in the cage clamp 410 that is formed when the cage clamp 410 is activated. A raised or sharpened shape can also be formed on embodiments having a gauge point at the operating end 440 that can be used to score or mark the insulation of a conductor wire prior to stripping, thereby eliminating the use of a marking pen and reducing errors caused by visual estimation of this distance.

FIG. 4b represents an alternate embodiment of the wiring device 400 of FIGS. 4 and 4a still utilizing an operating pin 430 for engaging and disengaging the cage clamp 410. In the embodiment illustrated, the cage clamp 410 is reversed such that the passage in the cage clamp 410 is adjacent to the lead hole 450 in the termination insulator 418. The pin 430 of the embodiments illustrated in FIGS. 4, 4a and 4b can be made of any rigid material capable of supporting the forces and stresses that each design of the pin 430 will produce when the pin 430 is engaged and disengaged. Some embodiments utilize electrically insulating and thermally stable materials such as strong plastics. Other embodiments use metals, alloys, ceramic, wood-based or paper-based products, thermosets, fiberglass, epoxy or any other suitable material.

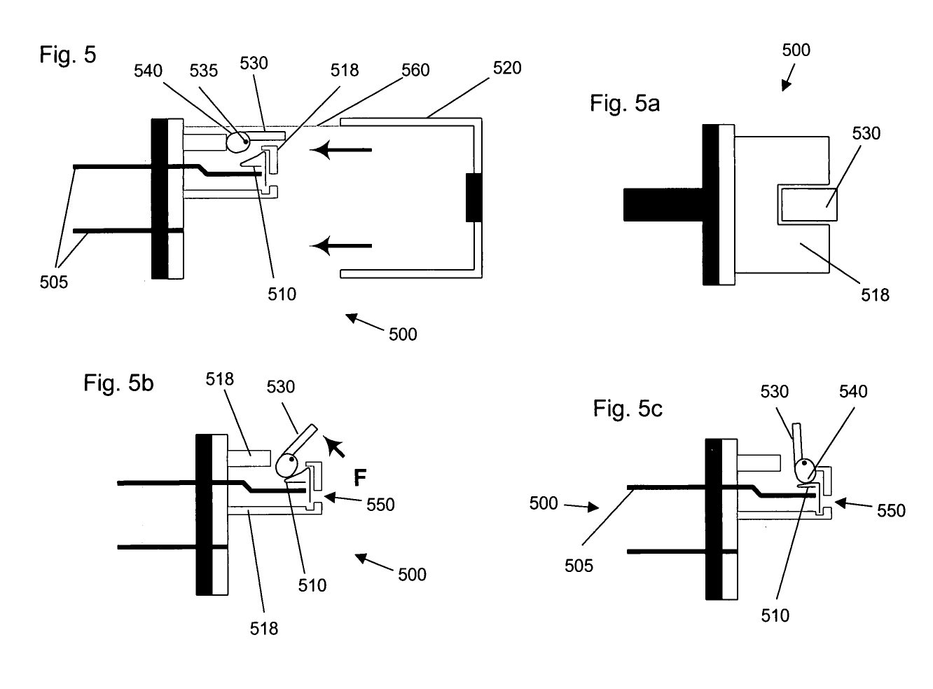

FIGS. 5, 5a, 5b and 5c illustrate another embodiment of a wiring device 500 that has an integral hand-operable actuator. The integral actuator of these embodiments includes a hinged or pinioned operating lever 530. Embodiments as illustrated in FIGS. 4, 4a and 4b include many of the components described above, such as terminal blades 505, a cage clamp 510, a termination insulator 418, a backshell 520 and a lead hole 550. The descriptions of the corresponding parts above apply here as well, and no further description will be provided. The integral actuator of embodiments illustrated is a longitudinal lever 530 attached to a cam 540, which is mounted to the termination insulator 418 via a pivot joint 535 along a line that does not run through the centroid of the cam 540. This offset mounting of the cam 540, allows the cam 540 to rotate in an eccentric manner about the pivot joint 535. The eccentric rotation leads to a travel of the cam 540 that is capable of applying operative engaging force to the cage clamp 510.

As illustrated in FIGS. 5, 5b and 5c, the various positions of the lever 530 along the complete range of its rotation fall in to three categories. FIG. 5 illustrates the first category where the cam 540 is fully disengaged from the cage clamp 510. Figure 5c illustrates another category where the cam 540 is fully engaged with the cage clamp 510 thereby fully compressing the cage clamp 510. Finally, FIG. 5b illustrates a final category including all the positions between or other than those illustrated previously, where the cam 540 is in a midway position between the fully engaged and fully disengaged states.

In the position illustrated by FIG. 5, the lever 530 is in its fully disengaged orientation. In this orientation, the cam 540 is not applying any engagement force to the cage clamp 510 so that the cage clamp 510 can exert full retentive force. Therefore, in this orientation, the cage clamp 510 exerts the full retentive force to a wire lead (not shown), if one resides in the lead hole 550.

In many such embodiments, the lever 530 in this position is in the only orientation that allows the insulating backshell 520 to be assembled onto the rest of the wiring device 500. The presence of the backshell 520 on the wiring device 500 also prevents the lever 530 from traveling off its fully disengaged position, thereby ensuring that the cam 540 is not rotated to engage the cage clamp 510. This provides a measure of certainty that the connection made by the cage clamp 510 will remain secure. A plane 560 the interior surface of the backshell 520 travels while assembled onto the wiring device 500 is shown that illustrates how the lever 530 of such embodiments will not interfere with the assembly of the backshell 520 only when the lever is fully disengaged. This not only ensures that the wiring device is fully assembled when the cage clamp 510 is correctly retaining the wire lead to be connected (not shown), but also ensures that the lever 530 and cam 540 will remain disengaged from the cage clamp 510 after assembly of the wiring device 500. Such design characteristics provide a level of confidence in the connections made to the wiring device that were heretofore unattainable.

The pivoting action of the lever 530 can be achieved through many mechanisms or structures as described for the lever 330 of FIG. 3 and all of the pivoting joints described therein apply equally to these embodiments. For instance, in some embodiments the pivot joint 535 consists of two protrusions extending from the termination insulator 518 on either side of the cam 540, while two corresponding cavities are formed in corresponding and adjacent positions on the cam 540. In such embodiments, when the cam 540 is inserted into the termination insulator 518 the two shapes will snap into the cavities in the cam 540, thereby forming the pivot joint 535. Alternatively, the protrusions can extend from the cam 540 and the cavities can be formed into the termination insulator 518. The protrusions can be cylindrical, hemispherical, conical, or any section or modification thereof or any other geometric shape that can provide the appropriate functions. Some embodiments utilize a metallic or nonmetallic hinge pin (not separately shown). The hinge pin can either be separate from and inserted through the cam 540 and held in place by the termination insulator 518, or it can be molded or integrated into the cam 540 and/or the termination insulator 518. In some such embodiments, the pivot joint 535 is a rivet running through the cam 540 and engaged with the outside of the walls of the termination insulator 518. Many more mechanisms can be used for the pivot joint 535 as well. Furthermore, the lever 530 can be manufactured as either a separate piece or integral with cam 540. In some embodiments, the lever 530 consists of multiple parts fitted together to fulfill the function described herein. Some embodiments include various shapes or surface treatment on the lever 530 to increase the grip a user is able to apply to the lever 530.

FIG. 5a illustrates the wiring device of FIG. 5 rotated 90 degrees about an axis running along the center of the wiring device 500 and backshell 520. The embodiment illustrated does not have the backshell 520 assembled but illustrates the lever 530 extending from the termination insulator 518. In this embodiment, the lever 530 is in the fully disengaged position. The lever 530 can be shaped, as illustrated, to extend beyond the termination insulator 518 in order to ease operation by the user. The lever 530 can also be shaped such that the end does not extend beyond the termination insulator 530 to deliberately make operation more difficult.

In the second position of the embodiment as illustrated in FIG. 5b, the lever 530 has been rotated from its fully disengaged position to the floating mid-position where the cam 540 can begin to contact or even apply engagement force to the cage clamp. An operating force F is applied to the lever 530 to move it from its first position illustrated in FIG. 5 to its second position as illustrated in FIG. 5b. Due to the design of the cam 540 and the physical properties of cams in general, a mechanical advantage can be created whereby the operating force F is amplified as it is applied to the cage clamp 510. In certain robust embodiments utilizing strong cage clamps 510, this allows a user to comfortably apply the operating force F necessary to produce the proper engagement of such cage clamps 510. The use of a cam 540, as illustrated in FIGS. 5, 5b and 5c, also limits the maximum force and displacement that is applied to the cage clamp 510. The maximum travel of the cam 540 can easily be designed into a particular embodiment, thereby reducing or eliminating the possibility of plastic deformation of the cage clamp 540. Again, reducing or removing the possibility of plastic deformation of the cage clamp 540 leads to increased reliability of the wiring device 500.

In certain embodiments, ridges or other structures are applied to the cam 540, the termination insulator 518, and/or other structures to create indications of the various positions of the lever 530. For instance, in some embodiments one ridge is present on the termination insulator 518 and a mating ridge is present at one angular position of the cam 540 extending along the thickness of the cam 540. Such ridges are designed as such common position indicators to identify when the cam 540 is fully disengaged. Additional ridges or other structures can be added to indicate other positions to the user as well.

In the position illustrated by FIG. 5b, the operator is preparing to provide engaging force to the cage clamp 510 by rotating the lever from the disengaged position. However, this position also prevents the backshell 520 from being assembled onto the wiring device 500. In embodiments where more than one conductor or lead of a multiconductor cable is terminated to such a wiring device 500, any or every operating lever 530 that is not properly positioned in the fully disengaged orientation will prevent the final assembly of the backshell 520. This also alerts the assembler to the improper assembly.

In the third position illustrated by FIG. 5c, the lever 530 has been rotated to the fully-engaged position. In this position, the cam 540 is in its most eccentric orientation, with respect to the cage clamp 510 and therefore is applying full engaging force to the cage clamp 510. However, as noted above, the maximum eccentricity and the full engaging force are designed in many embodiments to reliably stay within elastic deformation ranges for each particular cage clamp 510 that is used. As also described above, the pivot joint 535 is positioned so as to provide a great mechanical advantage where necessary, thereby reducing potential injury to assembly personnel. A significant mechanical advantage can be very useful in large connectors/wiring devices, where the force necessary to fully engage the cage clamp 510 is very high. In many embodiments, as the cam 540 is rotated toward a position where maximum engaging force is applied to the cage clamp 540, the area on the cam 540 contacting the cage clamp 510 is generally in alignment with the pivot joint 535 and the longitudinal axis of the lever 530. This relationship makes it more difficult for the resilient force of the cage clamp 510 to tend to rotate the cam 540 and provide feedback to the user through the lever 530. This creates a stable position and prevents the lever 530 from violently snapping back to the disengaged position due to the resilient force of the cage clamp 510 if the lever 530 is released by the user while in the fully engaged position. This stable position allows the user to insert a conductor wire into the lead hole 550 without having to apply continuous force to the lever 530, thereby easing usage of the wiring device 500. Ridges, as described above, or additional or alternative structures, can be added to provide positive feedback that the lever 530 is in the fully engaged position and to add to the stability of that position of the lever 530 and cam 540.

The lever 530, the cam 540 and the termination insulator 518 are designed to prevent access to and contact with the cage clamp 510, the terminal blade 505 or any other electrically-energized components on the inside of the wiring device 500, regardless of the position of the lever 530. The components described herein can be manufactured of any material of sufficient strength and rigidity to achieve the functions described herein. Many embodiments utilize electrically insulative and thermally stable materials for the cam 540, lever 530, pin joint 535 and termination insulator 518. In certain embodiments the cam 540 and lever 530 are made of strong plastic materials, however these items, the pivot joint 535, the backshell 520 and the termination insulator 518 can be made of any suitable thermoplastic, thermoset, epoxy, resin, fiberglass, metal, alloy, ceramic, wood-based or paper-based product or any other material or combinations of these or other materials. Additionally, these items can be made from different materials from one another. The cage clamp 510 and termination blades 505 of many embodiments are made of metals such as, but not limited to, steel, brass, and various alloys, but can be made of any material having the appropriate strength and resilience and capable of conducting electric current. An electrically conductive material can be coated onto other materials that are used, if required.

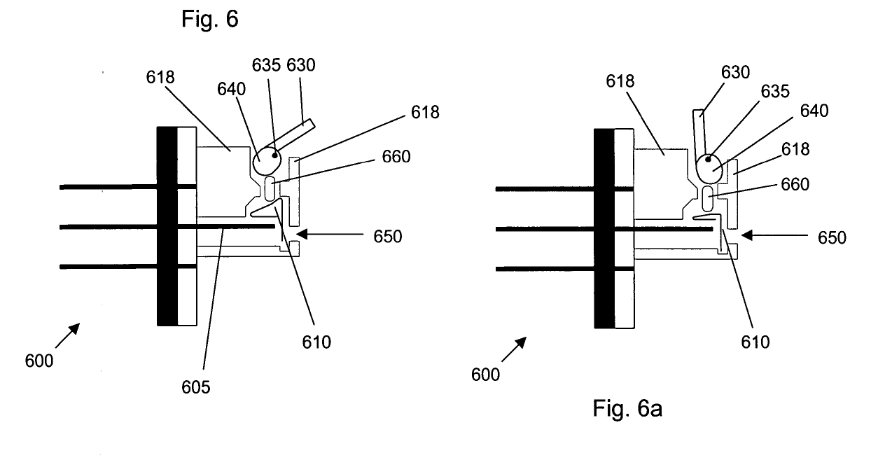

FIGS. 6 and 6a illustrate alternative embodiments of the wiring devices 600 to those FIGS. 5, 5a, 5b and 5c. In these alternative embodiments, the termination insulators 618 are formed such that the cam 640 is not proximate to, but rather is distant from the cage clamp 618. In such embodiments, the cam 640 does not directly engage and disengage the cage clamp 610. Rather, the cam 640 applies its force to a push rod 660 positioned within the termination insulator 618 between the cam 640 and the cage clamp 610. The push rod 660 is an elongated generally cylindrical rod having ends that contact the cam 640 and the cage clamp 610 to transmit force and motion from the cam 640 to the cage clamp 610.

FIG. 6 illustrates a lever 630 forming part of an actuator for the wiring device 600 in the mid-position between fully engaged and fully disengaged. The lever 630 has been rotated such that the cam 640 is beginning to apply a force to the push rod 660, and in return the push rod 660 is beginning to apply an engaging force to the cage clamp 610. The push rod 660 can serve the insulating functions allowing the cam 640, pivot joint 635 and the lever 630 to be made of metal as well as any of the other materials described above. In such embodiments, the push rod 660 is made of or coated with an electrically insulative material. The illustrated push rod 660 is shown as an example and any length, shape or sized item can be used that is capable of transferring the force applied from the cam 640 to the cage clamp 610. Such variations allow the actuator of these embodiments to be used on a variety of wiring devices and configurations including NEMA and other types.

FIG. 6a illustrates the wiring device 600 having the lever 630 rotated all the way to the fully engaged position, thereby positioning the push rod 660 so as to fully compress the cage clamp 610 allowing a lead to be inserted into or removed from the lead hole 650 to make or undo an electrical connection with the terminal blade 605. The embodiments illustrated otherwise include all of the functionality of the previously described embodiments.

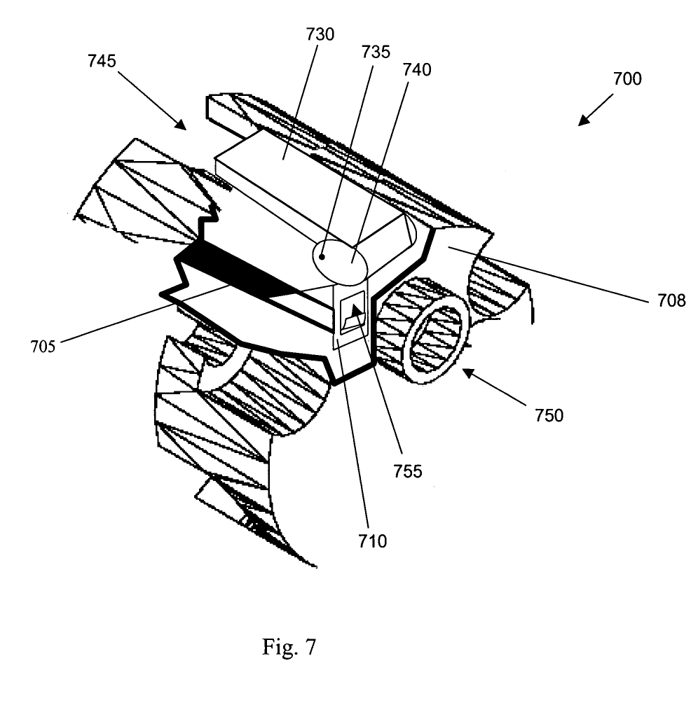

FIG. 7 is a perspective and partial cutaway view of the partially assembled embodiment of FIGS. 5, 5b and 5c. In the embodiment illustrated, the cam 710 and lever 730 are mounted in a recess 745 formed in the insulating insert 708 in proximity sufficient to engage and disengage the cage clamp 710 as it is rotated. The opening 755 in the cage clamp 710 is radially misaligned with the wire lead hole 750 through the insert 708 such that when the lever 730 is operated and the cage clamp 710 is engaged, the opening 755 will then be deflected to align with the wire lead hole 750 in the insert 708. When the lever 730 is returned to its rest position as illustrated, after a wire lead (not shown) is inserted, the cam 740 releases the cage clamp 710 and allows it to secure the lead against the terminal 705 held against another portion of the cage clamp 710. In the embodiment illustrated, the lever 730 and cam 740 are reversed from their orientation in FIG. 5, as they are situated such that the lever 730 is facing the forward end of the insert 708, the end where the terminal 705 extends out of the insert 708. Such design variations are utilized to allow the insert 708 to be implemented into many different types of wiring devices. This is an illustration of just one embodiment, and many variations can be used in many different applications, which include additional design elements such as those illustrated and described that are suitable to improve the performance of each particular embodiment.

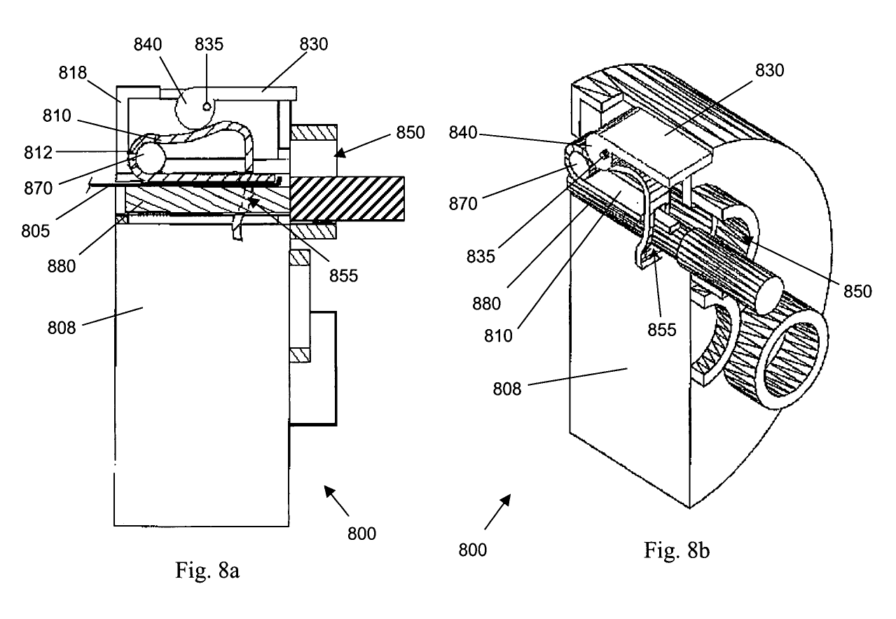

FIGS. 8a and 8b illustrate an alternative embodiment of the wiring device 700 embodiment illustrated in FIG. 7. FIG. 8a is a partial cutaway side view of the alternative embodiment, while FIG. 8b is a perspective and partial cutaway view of the embodiment of FIG. 8a. This embodiment illustrates one way in which an inserted lead 855 can be secured against the terminal blade 805 and the lower edge of the cage clamp 810. In this embodiment, a retainer 870 is utilized to control the location of the cage clamp 810 inside the termination insulator 818. The retainer 870 of this embodiment is a cylindrical strut running across the width of the illustrated portion of the termination insulator 818. The retainer 870 of this embodiment is also illustrated as being located near the dynamic bend 812 of the cage clamp 810, however in embodiments utilizing retainers 870 to increase control of the position of the cage clamp 810, the retainer 870 can be located at any position in the termination insulator 818 or the insert 808 that is capable of aiding in the control of the position of the cage clamp 810. In many embodiments, a retainer 870 is not utilized because the shape of the interior of the termination insulator 818 restricts the positioning of the cage clamp 810 to only the desired position and orientation.

As illustrated in both FIGS. 8a and 8b, a lead 855 is stripped of its insulation to the proper depth and is inserted into the lead hole 850 when the cage clamp 810 is engaged by the cam 840 and the lever 830. The mounting of the pivot joint 835 in a location offset from the centroid of the cam 840 ensures that the rotation of the cam 840 by the lever 830 will create the engaging force necessary to engage the cage clamp 810 and displace the lead opening 855 to align with the lead hole 850 to accept an inserted lead 880. When the lead 880 is inserted into the channel formed by the alignment of the lead hole 850, the lead opening 855 and the edge of the terminal blade 805, the lever 830 can then be moved to the disengaged position as illustrated, thereby rotating the cam 840 to the fully disengaged position and allowing the cage clamp 810 to apply a resilient retaining force to the lead 880 to retain it in the wiring device 800. This contact formed by the resilient force of the cage clamp 810 directed to hold the lead 880 against the terminal blade 805 forms a much more reliable and secure termination than is available in existing wiring devices. The thermal expansion and contraction, or cycling, of the wiring device 800 will not reduce the retaining force of the cage clamp 810 over time as it does in existing devices.

The use of electrically insulating materials for the cam 840 and/or the lever 830 increases safety. If the lead 880 is purposefully or inadvertently left energized during assembly, the user is insulated from the lead during the engagement and disengagement of the cage clamp 810, thereby reducing the possibility of electrical shock. This can also increase the degree of safety available when it is desirable or necessary to make “hot” connections with the lead(s) 880 energized.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

Many embodiments have been described herein. Many of the embodiments relate specifically to NEMA wiring devices. It should be known that the inventive elements described in those and other embodiments can be applied easily by those of skill in the art to any lead terminating application. The materials used for such embodiments are a matter of design choice and can be selected by one of ordinary skill in the art based upon the desired characteristics of the particular embodiments.

1. An electrical wiring device, comprising:
a conductive terminal;
a resilient cage clamp having a terminal opening adapted to accept the passage therethrough of a portion of the terminal, the cage clamp also having an actuation surface adapted to enlarge the terminal opening when the actuation surface is depressed;
a cage clamp actuator located in close proximity to the actuation surface so as to depress said actuation surface when the cage clamp actuator is operated; and
an insulating housing partially enclosing the terminal and the cage clamp and configured to retain at least a portion of the actuator;
wherein the actuator is adapted for hand-operation in order to depress said actuation surface.

2. The electrical wiring device of claim 1, wherein the terminal and housing conform to NEMA design standards.

3. The electrical wiring device of claim 1, further comprising an insulating cover adapted to mate with the housing and to encapsulate the cage clamp, the actuator and to partially enclose the terminal.

4. The electrical wiring device of claim 3, wherein the actuator further comprises:
a rotatable cam adapted to rotate between at least a first cam position and a second cam position, wherein when the cam is in the first cam position, the actuation surface is fully released and wherein when the cam is in the second cam position, the actuation surface is fully depressed; and
a cam lever attached to the cam and adapted to rotate the cam into the first and second cam positions.

5. The electrical wiring device of claim 4, wherein the cover can only be fully mated with the housing when the cam is in the first cam position.

6. The electrical wiring device of claim 5, wherein the cage clamp and terminal are adapted to conduct up to 10 amps of electrical current.

7. The electrical wiring device of claim 5, wherein the cage clamp and terminal are adapted to conduct up to 20 amps of electrical current.

8. The electrical wiring device of claim 5, wherein the cage clamp and terminal are adapted to conduct up to 40 amps of electrical current.

9. An electrical wiring device, comprising:
a blade-type wiring terminal;
a cage clamp in contact with the terminal, wherein the cage clamp is adapted to receive and retain an electrical lead when actuated, and wherein the cage clamp is further adapted to electrically and mechanically couple the wiring terminal with the electrical lead; and
an integral hand-operated actuator in proximity to the clamp and adapted to actuate the cage clamp.

10. The electrical wiring device of claim 9, wherein the actuator further comprises:
a cam mounted in operable proximity to the cage clamp and having at least first and second cam positions, wherein when the cam is in the first cam position, the cage clamp is fully released and wherein when the cam is in the second cam position, the cage clamp is fully actuated to form an opening adapted to receive a conductor lead; and
a cam lever attached to the cam and adapted to move the cam between the first and second cam positions.

11. The electrical wiring device of claim 10, further comprising a cover adapted to encapsulate the actuator and the cage clamp, wherein the cover can only be applied to the wiring device when the cam is in the first cam position.

12. The electrical wiring device of claim 10, wherein the cam further comprises a third cam position, wherein when the cam is rotated to the third cam position, the cage clamp is only partially actuated.

13. A NEMA wiring device comprising;
a plurality of terminals;
a plurality of cage clamps, one cage clamp for each terminal, wherein each cage clamp is in operable contact with one of the plurality of terminals and is adapted to provide a lead connection for its respective terminal.

14. The NEMA wiring device of claim 13, further comprising an integral, non conductive actuator for each of the plurality of cage clamps, wherein each actuator is adapted to activate its respective cage clamp to allow the insertion therein of a conductive lead so as to make an electrical connection between the lead and the respective terminal.

15. A method of connecting a conductive lead to a terminal in a NEMA wiring device, comprising:
operating a hand-operated actuator integral to the wiring device to open a lead receptacle in a cage clamp housed in the wiring device;
inserting a conductive lead into the lead receptacle formed in the cage clamp; and
releasing the hand-operated actuator in order to release the cage clamp and secure the lead in the wiring device

16. A method of manufacturing a wiring device, comprising:
molding a blade-shaped terminal;
forming a opening in a middle section of a flat resilient conductor;
forming the conductor generally into a loop with the opening along a middle portion of the loop;
extending the terminal partially through the opening;
forming a nonconductive actuator with a handle adapted to displace a portion of the conductor, wherein the actuator is formed such that is capable of being operated by hand; and
housing the conductor, the terminal and the actuator in an insulative body in a manner such that the terminal is generally parallel with the plane of the loop while extending partially within the opening and such that the actuator is in operable proximity with at least a portion of the resilient conductor;
wherein the body houses the conductor, the terminal and the actuator in a manner such that the resilient conductor rests at a state where the majority of the opening is misaligned with the terminal, and wherein the resilient conductor can be displaced from its rest position to a position such that the opening is aligned with the terminal to form an opening into which a conductive lead may be inserted, such that when the resilient member is returned to its rest position, it impinges the inserted lead against the terminal.

17. A wiring device that utilizes a cage clamp to connect a lead to a terminal, comprising:
an integral hand-operated actuation means for actuating the cage clamp, wherein when the actuation means is operated the cage clamp is opened to allow the insertion of the lead, and when the actuation means is further operated, the cage clamp secures the lead to the terminal.

18. A NEMA wiring device, comprising:
an electrical terminal;
a cage clamp in contact with the terminal, wherein the cage clamp has a termination opening adapted to accept a lead when the cage clamp is actuated;
multi-position actuation means for actuating the cage clamp in order to prepare the termination opening for acceptance of a lead; and
an insulative body to at least partially retain the terminal, the cage clamp and the actuation means.

19. A NEMA wiring device, comprising hand-operated actuator means integral to the wiring device to open and close a lead receptacle in a cage clamp housed in the wiring device.
